(19) United States
(12) Patent Application Publication
(10) Pub. No.: US 2016/0171762 A1
(43) Pub. Date: Jun. 16, 2016

(54) ELECTRONIC DEVICE AND METHOD FOR SIMPLIFYING MESH POINT CLOUD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZHE-RUI WEI, Shenzhen (CN); JING-JIE SHEN, Shenzhen (CN)

(21) Appl. No.: 14/735,613

(22) Filed: Jun. 10, 2015

(30) Foreign Application Priority Data
Dec. 10, 2014 (CN) 201410758133.5

(51) Int. Cl. G06T 17/20

(52) U.S. Cl. CPC G06T 17/20

(57) ABSTRACT

An electronic device implementing a point cloud system is configured to simplify a mesh point cloud. The point cloud system obtains a mesh point cloud from a mesh cloud file uploaded to the electronic device, and obtains information of a number of triangles formed by the mesh point cloud. A unit normal vector of each vertex point of each triangle is calculated, and a decision value of each vertex point of each triangle is calculated. The vertex points of each triangle are classified into a number of classification levels according to the decision values. A number of sample vertex points from each of the classification levels is selected, and a triangular structure of the sample vertex points is restored to obtain a simplified mesh point cloud.

### FIELD

The subject matter herein generally relates to point clouds, and more particularly to an electronic device and a method for simplifying a mesh point cloud by selecting sample points of the mesh point cloud.

### BACKGROUND

Generally, a mesh point cloud is made up of a plurality of points arranged in a triangular structure. The mesh point cloud is used to illustrate surface contours of an object. The mesh point cloud may have more points than necessary, which makes a data size of the mesh point cloud larger than necessary.

### BRIEF DESCRIPTION OF THE DRAWINGS

Implementations of the present technology will now be described, by way of example only, with reference to the attached figures.

FIG. 1 is a block diagram of an embodiment of an electronic device implementing a point cloud system for simplifying a mesh point cloud.

FIG. 2 is a block diagram of an embodiment of function modules of the point cloud system of FIG. 1.

FIG. 3 is a diagrammatic view of a plurality of adjacent triangles sharing a same vertex point.

FIG. 4 is a diagrammatic view of an embodiment of a method for restoring a triangular structure of a plurality of sample vertex points.

FIG. 5 is a flowchart of an embodiment of a method for simplifying a mesh point cloud.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

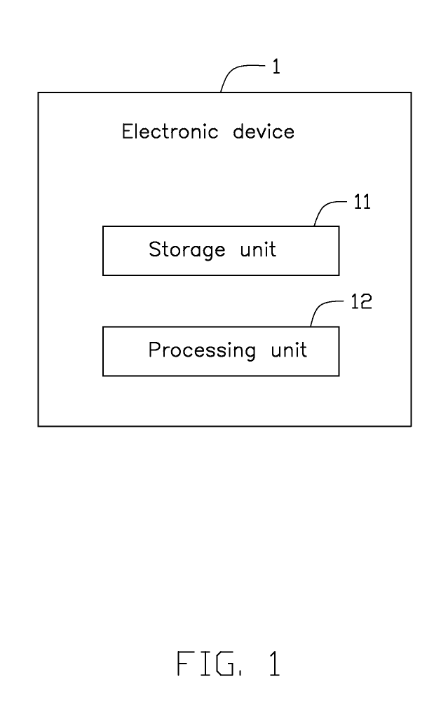

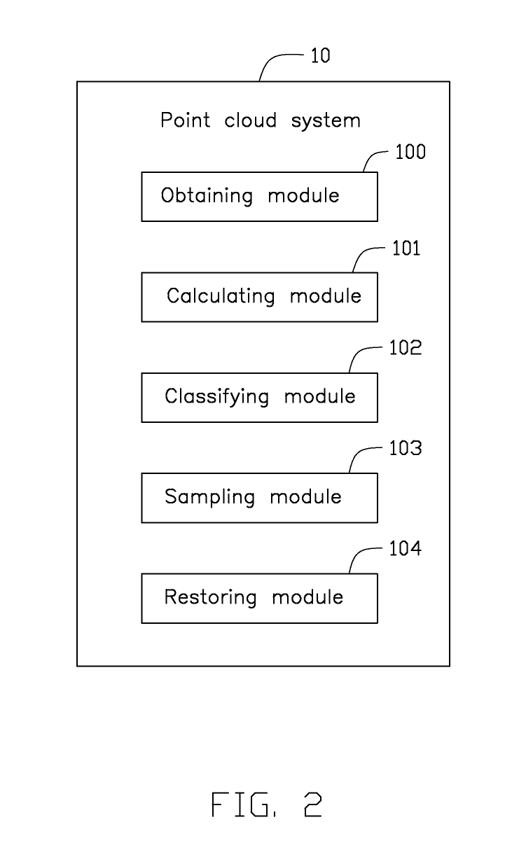

FIG. 1 illustrates an embodiment of an electronic device 1 implementing a point cloud system 10 (shown in FIG. 2) for simplifying a mesh point cloud. The electronic device 1 can include a storage unit 11 and a processing unit 12. The point cloud system 10 can be stored in the storage unit 10. The point cloud system 10 can simplify a mesh point cloud.

Referring to FIG. 2, the point cloud system 10 can include a plurality of modules, such as an obtaining module 100, a calculating module 101, a classifying module 102, a sampling module 103, and a restoring module 104. The modules 100-104 can include one or more software programs in the form of computerized codes stored in the storage unit 11. The computerized codes can include instructions executed by the processing unit 12 to provide functions for the modules 100-104.

The obtaining module 100 can obtain a mesh point cloud from a mesh cloud file uploaded to the electronic device 1, and obtain information of a plurality of triangles formed by the mesh point cloud. The information of the plurality of triangles can include coordinate values of the vertex points of the triangles.

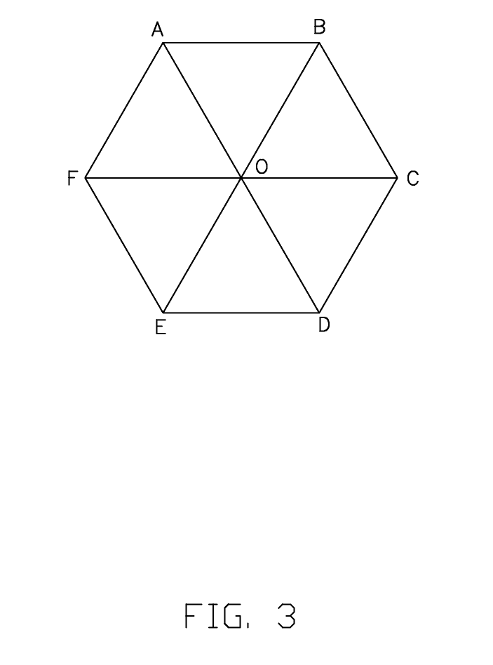

The calculating module 101 can calculate a unit normal vector of each vertex point of each triangle. In at least one embodiment, the unit normal vector of each vertex point can be calculated by first determining all adjacent triangles of each vertex point. The adjacent triangles are the triangles that share the same vertex point. For example, referring to FIG. 3, the adjacent triangles of the vertex point O include a first triangle AOB, a second triangle BOC, a third triangle COD, a fourth triangle DOE, a fifth triangle EOF, and a sixth triangle FOA. A unit normal vector of each of the adjacent triangles can be calculated, and an average unit normal vector of the adjacent triangles of the vertex point can be calculated. The average unit normal vector is the unit normal vector of the vertex point O.

The calculating module 101 can further calculate a decision value of each vertex point. In at least one embodiment, the decision value of a vertex point can be calculated by first calculating a cosine value of an included angle between the unit normal vector of the vertex point and the unit normal vector of each adjacent vertex point, the adjacent vertex points being the vertex points of the adjacent triangles. An average cosine value of the included angles can be calculated. The average cosine value is the decision value of the vertex point. The decision value can be greater than or equal to 0 and less than or equal to 1.

The classifying module 102 can classify the plurality of vertex points into a plurality of classification levels according to the decision values. In at least one embodiment, the vertex points can be arranged in sequence from a smallest decision value to a largest decision value. The vertex points can be classified into an “N” number of classification levels “Cᵢ” (i=1, 2, . . . , N) according to the decision values.

The sampling module 103 can select a plurality of sample vertex points from each of the classification levels. In detail, the plurality of sample vertex points from each of the classification levels can be selected by calculating a total number of required sample vertex points “Number_{required}” of all of the classification levels, calculating a required number of sample vertex points “Cᵢₛₐₘₚₗₑ” from each classification level to be selected, and selecting the plurality of sample vertex points from the classification levels in sequence from a first classification level C₁ to a last classification level C_{N} according to the required number of sample vertex points for each classification level.

In at least one embodiment, the total number of required sample vertex points of all of the classification levels is calculated according to the formula: Number_{required}=k*Numberₜₒₜₐₗ, wherein “k” is a predetermined sampling ratio, and “Numberₜₒₜₐₗ” is equal to the number of vertex points of all of the classification levels. In at least one embodiment, the required number of sample vertex points to be selected from each classification level is calculated according to the formula: Cᵢₛₐₘₚₗₑ=Rᵢ*Number_{required}, wherein “Rᵢ” is a proportion of Number_{required} predetermined by a user. In at least one embodiment, the required number of sample vertex points to be selected from each classification level decreases as the classification level increases. For example, the first classification level C₁ requires the greatest number of sample vertex points to be selected, and the last classification level C_{N} requires the fewest number of sample vertex points to be selected.

In at least one embodiment, to select the sample vertex points, the sampling module 103 can compare a total number of vertex points Number_{C1} of the first classification level to the corresponding required number of sample vertex points C₁ₛₐₘₚₗₑ. When the total number of vertex points of the first classification level is greater than or equal to the corresponding required number of sample vertex points, the sampling module 103 selects the required number of sample vertex points C₁ₛₐₘₚₗₑ from the first classification level. When the total number of vertex points of the first classification level is less than the required number of sample vertex points, the sampling module 103 selects all of the vertex points of the first classification level, and adds a remainder number to the required number of sample vertex points to be selected from the second classification level. The remainder number is calculated according to the formula: R₁*Number_{required}−Number_{C1}. Thus, when the remainder number from the first classification level is added to the required number of sample vertex points to be selected from the second classification level, the required number of sample vertex points to be selected from the second classification level is calculated according to the formula: R₂*Number_{required}+(R₁*NUMber_{required}−Number_{C1}). A process of selecting the sample vertex points from the classification levels and adding a corresponding remainder number to the required number of sample vertex points of a next classification level can be repeated, until the sample vertex points have been selected from all of the classification levels.

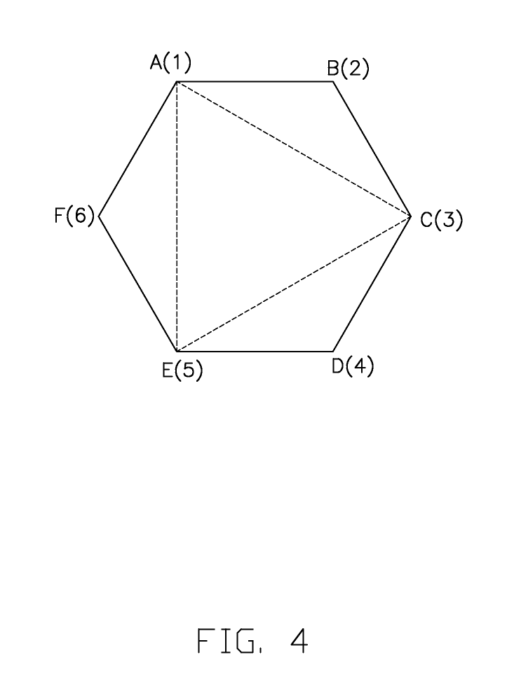

After the sample vertex points from all of the classification levels have been selected, the restoring module 104 can restore a triangular structure of the plurality of sample vertex points to obtain a simplified mesh point cloud. In detail, in at least one embodiment, the restoring module 104 can select a reference vertex point not selected as one of the plurality of sample vertex points, and determine a clockwise sequence of all of the plurality of sample vertex points around the reference vertex point. The triangular structure of the sample vertex points can be restored by connecting the odd-numbered sample vertex points in sequence from a first sample vertex point to a last odd-numbered sample vertex point and back to the first sample vertex point, when there are an even number of sample vertex points around the reference vertex point which is deleted after the sampling. For example, referring to FIG. 4, a first sample vertex point A can be connected to a third sample vertex point C to create a triangle ABC, the third sample vertex point C can be connected to a fifth sample vertex point E to create a triangle CDE, and the fifth sample vertex point E can be connected back to the first sample vertex point to create a triangle EFA. When there are an odd number of sample vertex points around the reference vertex point, the connection of the last odd-numbered sample vertex point back to the first sample vertex point is not necessary.

By using the electronic device 1 implementing the point cloud system 10, a mesh point cloud can be effectively simplified, thereby reducing a data size of the mesh point cloud.

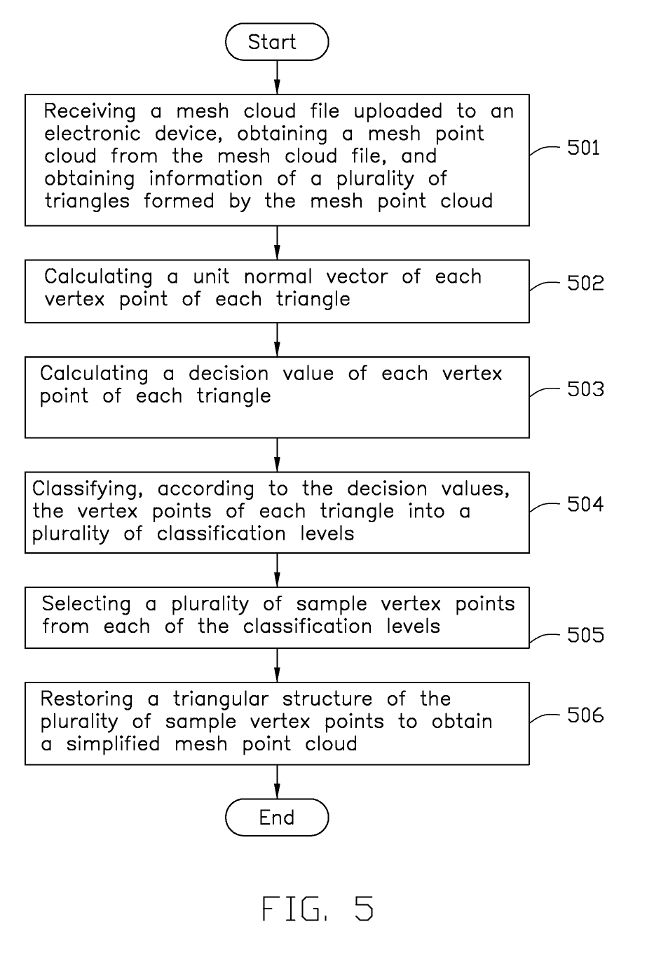

FIG. 5 illustrates a flowchart of an exemplary method for simplifying a mesh point cloud. The example method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 501.

At block 501, a mesh point cloud can be obtained from a mesh cloud file uploaded to an electronic device, and information of a plurality of triangles formed by the mesh point cloud can be obtained. In at least one embodiment, the information includes coordinate values of vertex points of the triangles.

At block 502, a unit normal vector of each vertex point of each triangle can be calculated. In at least one embodiment, the unit normal vector of each vertex point can be calculated by first determining all adjacent triangles of each vertex point. The adjacent triangles are the triangles that share the same vertex point. A unit normal vector of each of the adjacent triangles can be calculated, and an average unit normal vector of the adjacent triangles of the vertex point can be calculated. The average unit normal vector is the unit normal vector of the vertex point.

At block 503, a decision value of each vertex point of each triangle can be calculated. In at least one embodiment, the decision value of a vertex point can be calculated by first calculating a cosine value of an included angle between the unit normal vector of the vertex point and the unit normal vector of each adjacent vertex point, the adjacent vertex points being the vertex points of the adjacent triangles. An average cosine value of the included angles can be calculated. The average cosine value is the decision value of the vertex point. The decision value can be greater than or equal to 0 and less than or equal to 1.

At block 504, the vertex points of each triangle can be classified into a plurality of classification levels according to the decision values. In at least one embodiment, the vertex points can be arranged in sequence from a smallest decision value to a largest decision value. The vertex points can be classified into an “N” number of classification levels “Cᵢ” (i=1, 2, . . . , N) according to the decision values.

At block 505, a plurality of sample vertex points from each of the classification levels can be selected. In detail, the plurality of sample vertex points from each of the classification levels can be selected by calculating a total number of required sample vertex points “Number_{required}” of all of the classification levels, calculating a required number of sample vertex points “Cᵢₛₐₘₚₗₑ” from each classification level to be selected, and selecting the plurality of sample vertex points from the classification levels in sequence from a first classification level C₁ to a last classification level C_{N} according to the required number of sample vertex points for each classification level.

In at least one embodiment, the total number of required sample vertex points of all of the classification levels is calculated according to the formula: Number_{required}=k*Numberₜₒₜₐₗ, wherein “k” is a predetermined sampling ratio, and “Numberₜₒₜₐₗ” is equal to the number of vertex points of all of the classification levels. In at least one embodiment, the required number of sample vertex points to be selected from each classification level is calculated according to the formula: Cᵢₛₐₘₚₗₑ=Rᵢ*Number_{required}, wherein “Rᵢ” is a proportion of Number_{required} predetermined by a user. In at least one embodiment, the required number of sample vertex points to be selected from each classification level decreases as the classification level increases. For example, the first classification level C₁ requires the greatest number of sample vertex points to be selected, and the last classification level C_{N} requires the fewest number of sample vertex points to be selected.

In at least one embodiment, to select the sample vertex points, a total number of vertex points Number_{C1} of the first classification level can be compared to the corresponding required number of sample vertex points C₁ₛₐₘₚₗₑ. When the total number of vertex points of the first classification level is greater than or equal to the corresponding required number of sample vertex points, the required number of sample vertex points C₁ₛₐₘₚₗₑ can be selected from the first classification level. When the total number of vertex points of the first classification level is less than the required number of sample vertex points, all of the vertex points of the first classification level can be selected, and a remainder number can be added to the required number of sample vertex points to be selected from the second classification level. The remainder number is calculated according to the formula: R₁*Number_{required}−Number_{C1}. Thus, when the remainder number from the first classification level is added to the required number of sample vertex points to be selected from the second classification level, the required number of sample vertex points to be selected from the second classification level is calculated according to the formula: R₂*Number_{required}+(R₁*Number_{required}−Number_{C1}). A process of selecting the sample vertex points from the classification levels and adding a corresponding remainder number to the required number of sample vertex points of a next classification level can be repeated, until the sample vertex points have been selected from all of the classification levels.

At block 506, a triangular structure of the plurality of sample vertex points can be restored to obtain a simplified mesh point cloud. In detail, in at least one embodiment, a reference vertex point can be selected. The reference vertex point is a vertex point not selected as one of the plurality of sample vertex points. A clockwise sequence of all of the plurality of sample vertex points around the reference vertex point can be determined. The triangular structure of the sample vertex points can be restored by connecting the odd-numbered sample vertex points in sequence from a first sample vertex point to a last odd-numbered sample vertex point and back to the first sample vertex point, when there are an even number of sample vertex points around the reference vertex point which is deleted after the sampling, thereby restoring the triangular structure of the sample vertex points and obtaining the simplified mesh point cloud. When there is an odd number of sample vertex points around the reference vertex point, the connection of the last odd-numbered sample vertex point back to the first odd-numbered sample vertex point is not necessary since they have already been connected.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for simplifying a mesh point cloud, the method comprising:
obtaining, by an electronic device, a mesh point cloud from a mesh cloud file uploaded thereto;
obtaining information of a plurality of triangles formed by the mesh point cloud;
calculating, by the electronic device, a unit normal vector of each vertex point of each triangle;
calculating, by the electronic device, a decision value of each vertex point of each triangle;
classifying, by the electronic device and according to the decision values, the vertex points of each triangle into a plurality of classification levels;
selecting, by the electronic device, a plurality of sample vertex points from each of the classification levels; and
restoring, by the electronic device, a triangular structure of the plurality of sample vertex points to obtain a simplified mesh point cloud.

2. The method as in claim 1, wherein the information of the plurality of triangles formed by the mesh point cloud comprises coordinate values of the vertex points of the triangles.

3. The method as in claim 1, wherein the unit normal vector of each vertex point of each triangle is calculated by:
determining all adjacent triangles of each vertex point, the adjacent triangles being the triangles that share the same vertex point;
calculating a unit normal vector of each of the adjacent triangles; and
calculating an average unit normal vector of the adjacent triangles of each vertex point, the average unit normal vector being the unit normal vector of the vertex point.

4. The method as in claim 3, wherein the decision value of each vertex point of each triangle is calculated by:
calculating a cosine value of an included angle between the unit normal vector of the vertex point and the unit normal vector of each adjacent vertex point, the adjacent vertex points being the vertex points of the adjacent triangles; and
calculating an average cosine value of the included angles, the average cosine value being the decision value of the vertex point.

5. The method as in claim 4, wherein the decision value is greater than or equal to 0 and less than or equal to 1.

6. The method as in claim 4, wherein the vertex points are classified into the plurality of classification levels by:
arranging the vertex points in sequence from a smallest decision value to a largest decision value; and
classifying the vertex points arranged in sequence into an “N” number of classification levels “Cᵢ” (i=1, 2, . . . , N) according to the decision values.

7. The method as in claim 6, wherein the plurality of sample vertex points of the classification levels are selected by:
calculating a total number of required sample vertex points “Number_{required}” of all of the classification levels;
calculating a required number of sample vertex points “Cᵢₛₐₘₚₗₑ” for each classification level to be selected; and
selecting the plurality of sample vertex points of the classification levels in sequence from a first classification level C₁ to a last classification level C_{N} according to the required number of sample vertex points for each classification level.

8. The method as in claim 7, wherein:
the total number of required sample vertex points of all of the classification levels is calculated according to the formula: Number_{required}=k*Numberₜₒₜₐₗ, wherein “k” is a predetermined sampling ratio, and “Numberₜₒₜₐₗ” is equal to the total number of vertex points of all of the classification levels;
the required number of sample vertex points to be selected for each classification level is calculated according to the formula: Cᵢₛₐₘₚₗₑ=Rᵢ*Number_{required}, wherein “Rᵢ” is a proportion of Number_{required} predetermined by a user; and
the required number of sample vertex points to be selected from each classification level decreases as the classification level increases.

9. The method as in claim 8, wherein a process of selecting the sample vertex points of the classification levels in sequence from the first classification level to the last classification level comprises:
comparing a total number of vertex points Number_{C1} of the first classification level to the corresponding required number of sample vertex points C₁ₛₐₘₚₗₑ;
selecting the required number of sample vertex points C₁ₛₐₘₚₗₑ when the total number of vertex points Number_{C1} of the first classification level is greater than or equal to the corresponding required number of sample vertex points C₁ₛₐₘₚₗₑ;
selecting all of the vertex points of the first classification level when the total number of vertex points Number_{C1} is less than the required number of sample vertex points C₁ₛₐₘₚₗₑ;
adding a remainder number to the required number of sample vertex points of the second classification level when the total number of vertex points Number_{C1} is less than the required number of sample vertex points C₁ₛₐₘₚₗₑ, the remainder number calculated according to the formula: R₁*Number_{required}−Number_{C1}; and
repeating a process of selecting the sample vertex points from every classification level, and adding a corresponding remainder number to the required number of sample vertex points of a next classification level when the total number of vertex points Number_{C1} is less than the required number of sample vertex points Cᵢₛₐₘₚₗₑ.

10. The method as in claim 1, wherein a process of restoring a triangular structure of the plurality of sample vertex points comprises:
selecting a reference vertex point not selected as one of the plurality of sample vertex points;
determining a clockwise sequence of all of the plurality of sample vertex points around the reference vertex point; and
connecting the odd-numbered sample vertex points in sequence from a first sample vertex point to a last odd-numbered sample vertex point when there are an odd number of sample vertex points around the reference vertex point, until the triangular structure of the plurality of sample vertex points is restored.

11. The method claimed in claim 10, wherein the step of connecting the odd-numbered sample vertex points in sequence further comprises connecting the last odd-numbered sample vertex point back to the first sample vertex point when there are an even number of sample vertex points around the reference vertex point.

12. An electronic device implementing a point cloud system for simplifying a mesh point cloud, the point cloud system configured to:
obtain a mesh point cloud from a mesh cloud file uploaded to the electronic device, and obtain information of a plurality of triangles formed by the mesh point cloud;
calculate a unit normal vector of each vertex point of each triangle;
calculate a decision value of each vertex point of each triangle;
classify, according to the decision values, the vertex points of each triangle into a plurality of classification levels;
select a plurality of sample vertex points from each of the classification levels; and
restore a triangular structure of the plurality of sample vertex points to obtain a simplified mesh point cloud.

13. The electronic device as in claim 12, wherein the information of the plurality of triangles formed by the mesh point cloud comprises coordinate values of the vertex points of the triangles.

14. The electronic device as in claim 12, wherein the unit normal vector of each vertex point of each triangle is calculated by:
determining all adjacent triangles of each vertex point, the adjacent triangles being the triangles that share the same vertex point;
calculating a unit normal vector of each of the adjacent triangles; and
calculating an average unit normal vector of the adjacent triangles of each vertex point, the average unit normal vector being the unit normal vector of the vertex point.

15. The electronic device as in claim 14, wherein the decision value of each vertex point of each triangle is calculated by:
calculating a cosine value of an included angle between the unit normal vector of the vertex point and the unit normal vector of each adjacent vertex point, the adjacent vertex points being the vertex points of the adjacent triangles; and
calculating an average cosine value of the included angles, the average cosine value being the decision value of the vertex point, and the decision value being greater than or equal to 0 and less than or equal to 1.

16. The electronic device as in claim 15, wherein the vertex points are classified into the plurality of classification levels by:
arranging the vertex points in sequence from a smallest decision value to a largest decision value; and
classifying the vertex points arranged in sequence into an “N” number of classification levels “Cᵢ” (i=1, 2, . . . , N) according to the decision values.

17. The electronic device as in claim 16, wherein the plurality of sample vertex points of the classification levels are selected by:
calculating a total number of required sample vertex points “Number_{required}” of all of the classification levels;
calculating a required number of sample vertex points “Cᵢₛₐₘₚₗₑ” for each classification level to be selected; and
selecting the plurality of sample vertex points of the classification levels in sequence from a first classification level C₁ to a last classification level C_{N} according to the required number of sample vertex points for each classification level.

18. The electronic device as in claim 17, wherein:
the total number of required sample vertex points of all of the classification levels is calculated according to the formula: Number_{required}=k*Numberₜₒₜₐₗ, wherein “k” is a predetermined sampling ratio, and “Numberₜₒₜₐₗ” is equal to the total number of vertex points of all of the classification levels;
the required number of sample vertex points to be selected for each classification level is calculated according to the formula: Cᵢₛₐₘₚₗₑ=Rᵢ*Number_{required}, wherein “Rᵢ” is a proportion of Number_{required} predetermined by a user; and
the required number of sample vertex points to be selected from each classification level decreases as the classification level increases.

19. The electronic device as in claim 18, wherein a process of selecting the sample vertex points of the classification levels in sequence from the first classification level to the last classification level comprises:
comparing a total number of vertex points Number_{C1} of the first classification level to the corresponding required number of sample vertex points C₁ₛₐₘₚₗₑ;
selecting the required number of sample vertex points C₁ₛₐₘₚₗₑ when the total number of vertex points Number_{C1} of the first classification level is greater than or equal to the corresponding required number of sample vertex points C₁ₛₐₘₚₗₑ;
selecting all of the vertex points of the first classification level when the total number of vertex points Number_{C1} is less than the required number of sample vertex points C₁ₛₐₘₚₗₑ;
adding a remainder number to the required number of sample vertex points of the second classification level when the total number of vertex points Number_{C1} is less than the required number of sample vertex points C₁ₛₐₘₚₗₑ, the remainder number calculated according to the formula: R₁*Number_{required}−Number_{C1}; and
repeating a process of selecting the sample vertex points for every classification level, and adding a corresponding remainder number to the required number of sample vertex points of a next classification level when the total number of vertex points Number_{Ci} is less than the required number of sample vertex points Cᵢₛₐₘₚₗₑ.

20. The electronic device as in claim 12, wherein:
a process of restoring a triangular structure of the plurality of sample vertex points comprises selecting a reference vertex point not selected as one of the plurality of sample vertex points, determining a clockwise sequence of all of the plurality of sample vertex points around the reference vertex point, and connecting the odd-numbered sample vertex points in sequence, until the triangular structure of the plurality of sample vertex points is restored;
the electronic device comprises a storage unit and a processing unit;
the storage unit is configured to store the a plurality of instructions of a plurality of modules of the point cloud system;
the processing unit is configured to execute the plurality of instructions of the plurality of modules of the point cloud system;
the plurality of modules comprises an obtaining module, a calculating module, a classifying module, a sampling module, and a restoring module;
the obtaining module is configured to obtain the mesh point cloud from the mesh cloud file, and obtain the information of the plurality of triangles;
the calculating module is configured to calculate the unit normal vector of each vertex point of each triangle, and calculate the decision value of each vertex point of each triangle according to the unit normal vectors of the triangles;
the classifying module is configured to classify the vertex points of each triangle into the plurality of classification levels;
the sampling module is configured to select the plurality of sample vertex points from each of the classification levels; and
the restoring module is configured to restore the triangular structure of the plurality of sample vertex points to obtain the simplified mesh point cloud.
